(19) United States
(12) Patent Application Publication
(10) Pub. No.: US 2018/0017325 A1
(43) Pub. Date: Jan. 18, 2018

(54) APPARATUS FOR DRYING CONVEYED MATERIAL

(71) Applicant: Schenck Process UK Limited, Edinburgh (GB)

(72) Inventor: Martin Chisholm, Edinburgh (GB)

(21) Appl. No.: 15/543,674

(22) PCT Filed: Jan. 14, 2016
(86) PCT No.: PCT/GB2016/050086

§ 371 Date: Jul. 14, 2017

(30) Foreign Application Priority Data
Jan. 14, 2015 (GB) 1500569.7

(51) Int. Cl. F26B 17/10; B07B 11/08; B07B 7/06; F26B 3/10; B04C 3/00

(52) U.S. Cl. CPC F26B 17/107; F26B 3/10; B04C 3/00; B07B 7/06; B07B 11/08

(57) ABSTRACT

There is herein described apparatus for drying material or for conveying material. More particularly, the present invention relates to apparatus for drying conveyed material such as pneumatically conveyed material or for conveying oversized material.

### FIELD OF THE INVENTION

The present invention relates to apparatus for drying material or for conveying material. More particularly, the present invention relates to apparatus for drying conveyed material such as pneumatically conveyed material or for conveying oversized material.

### BACKGROUND OF THE INVENTION

It is a known problem in some pneumatic conveying applications that small quantities of damp material can periodically pass through the conveying pipeline and cause blockages.

A typical application where this problem occurs is systems used to pneumatically convey pulverised coal into blast furnace tuyeres. In this type of plant, condensation can form on the walls of the silos used to store the freshly milled and dried coal. Fine coal then attaches to the moisture film and in time a layer of damp coal builds up. This build up can detach from the silo wall and result in clumps of damp coal passing through the downstream stream injection system. In the case of blast furnace coal injection systems this causes blockages of the small injection pipelines feeding the furnace tuyeres. The quantity of damp coal is relatively small, typically, 500 mls, however the resulting blockages are very disruptive to the blast furnace operation and are difficult to clear.

To counter the problem of damp coal clumps entering blast furnace injection systems two methods are commonly employed:
1). Vibratory screens are installed before the pneumatic conveying vessels. These screens remove any damp coal and other oversized material that may be present in the feed stock and discharge it to a trash skip. Disadvantages of using vibratory screens in the way are:
   a). The screen decks become blinded by fibrous material that is often present in the coal and require frequent cleaning.
   b). Failure to routinely clean the screen deck results in clogging. This causes fine coal intended for injection to the furnace to be discharged to the trash skip so that it is lost to the process. It can also result in coal dust being released to the surroundings.
   c). Installation of a vibratory screen and the associated rotary valve increases the complexity, power consumption and maintenance of the system.
   d). Installation of a vibratory screen and rotary valve increase the overall height of the plant by approximately 2 metres which increases the cost of the structure.
2). A static filter installed in the main pneumatic conveying pipe line to catch damp material. These in-line filters are cleaned either manually or automatically by means of an arrangement of actuated valves.
   a). The manual system requires maintenance and may require that the system is stopped.
   b). Both the manual and automatic systems discharge coal to a waste hopper so the coal is lost to the process.
   c). The filter element is normally installed directly in the coal/transport gas stream which forces any fibrous and tramp material into the filter element so that it becomes enmeshed. This results in clogging of the filter element which may require manually clearing.

It is a further known problem that when oversized material containing rocks and/or debris is conveyed this can lead to the clogging and blockages forming in the apparatus conveying the material. The present invention addresses this problem.

It is an object of at least one aspect of the present invention to obviate or mitigate at least one or more of the aforementioned problems.

It is a further object of at least one aspect of the present invention to provide an apparatus and method capable of drying pneumatically conveyed material.

It is a yet further object of the present invention to provide an apparatus capable of conveying oversized material.

### SUMMARY OF THE INVENTION

According to a first aspect of the present invention there is provided apparatus for drying material comprising:

a casing which has an internal channel extending around the inner circumference of the casing;

a filter element located within the casing;

an inlet through which damp material and a transport gas is capable of being fed into the casing and the internal channel; and

an outlet through which dried material and transport gas is capable of exiting the casing;

wherein the damp material is dried during its time in the internal channel of the casing and once dried is capable of passing through the filter element and exiting through the outlet.

Generally speaking, the present invention resides in the provision of apparatus for drying material which may be conveyed. The material may be pneumatically conveyed.

The apparatus may be capable of drying any type of particulate material, granular or powder-like material that has a degree of dampness. In particular embodiments, the apparatus may be placed in a pulverised coal injection system where the coal is damp.

The apparatus may be described as a cyclonic separator and drier.

The casing may be circular in shape.

The casing may be hollow with an internal circular channel which extends in an annular fashion around the inside of the casing. The diameter of the internal channel may be about 20 cm to about 100 cm.

The internal channel may have a surface extending in a circular fashion onto which clumps of damp material may be displaced onto. The surface of the circular channel may be smooth or may have intrusions against which agglomerated material will collide causing them to break down more quickly.

The outer surface of the circular channel may be equipped with an external source of heat. Heat transmitted through the wall of the circular channel by conduction may be intended to enhance evaporation causing the damp clumps to be dried more quickly.

The filter element may have an end plate onto which optionally may be attached a circular member (e.g. a circular member) and a filter element. The filter element may be tubular in shape.

The filter element may be made from any suitable type of filter device.

In a particular embodiment, the filter element may comprise a series of rings and vertical bars. The vertical bars may optionally be vertical round bars. The series of rings may provide a tubular filter element with a diameter of 5 cm to about 40 cm. The gaps between the rings may be about 0.3 cm to about 2.0 cm.

The end plate in the filter element may comprise a series of apertures which can be used to attach the filter element to the rest of the apparatus using nut, bolts and the like. However, the filter element may be attached to the casing and the rest of the apparatus using any suitable type of mechanical and/or adhesive means.

The inlet may be an inlet pipe through which damp material is capable of being fed.

The inlet pipe may be mounted tangentially or substantially tangentially onto the casing. In alternative embodiments the inlet pipe may be attached to the casing in any suitable angle such as about +/−20 degrees from the tangent.

The inlet may have a diameter of about 2 cm to about 40 cm.

Attached to the casing there may be a conduit (e.g. a pipe) through which the dried material may exit the casing. The conduit may be in the form of a high angle bend such as a 90 degree T-bend. The conduit may have a diameter of about 2 cm to about 40 cm.

The conduit may be connected to the outlet through which dried material is capable of exiting.

The material outlet may have a diameter of about 2 cm to about 40 cm.

This apparatus may be installed in the pneumatic conveying pipeline of such applications. Its purpose is to capture any damp material and prevent it from passing into the downstream system where it could cause pipe blockages. The clumps of damp material may be held within the casing of the apparatus. The passage of transport gas evaporates the moisture causing the clumps of material to progressively dry out and disintegrate so that the material can pass to the downstream process.

The apparatus is also capable of being retro-fitted to existing systems.

According to a second aspect of the present invention there is provided a method for drying damp material, said method comprising: providing a casing which has an internal channel extending around the inner circumference of the casing;

providing a filter element located within the casing;

providing an inlet through which damp material and a transport gas is capable of being fed into the casing and the internal channel; and

providing an outlet through which dried material and transport gas is capable of exiting;

wherein the damp material is dried during its time in the internal channel of the casing and once dried is capable of passing through the filter element and exiting through the outlet.

The method may use the apparatus as defined in the first aspect.

In use, material and transport gas may enter the casing through the inlet. The inlet may be located at a high angle to the casing and preferably tangentially or substantially tangentially.

The material may be any type of damp material such as particulate material, powder or granular type material that contains a degree of dampness. In particular embodiments, the apparatus may be placed in a pulverised coal injection system where the coal is damp.

The level of dampness (i.e. moisture) in the clumps of damp material may range from about 1 wt. %-30 wt. % or about 0 wt. %-1 wt. % of the total weight of the material.

The size of the particles of the damp material being fed into the inlet may be about 0.5 cm to 20 cm.

The particles of the damp material may be travelling at a speed of about 4 ms⁻¹ to about 30 ms⁻¹ when they enter the casing.

The volume of material capable of being fed into the apparatus may range up to about 60 tonnes per hour or even higher.

The damp material on exiting the inlet may enter the casing.

The damp material may circulate around the periphery in the internal channel of the casing and may become lodged on the inner surface of the casing. Any clumps of damp material that may be present are thrown to the periphery of the casing due to cyclonic action and are prevented from passing through the system. The finer dry material may remain entrained in the transport gas flow and may be drawn towards the centre of the casing passing through the filter element and downwards. The dried material may then pass through a conduit e.g. a bent pipe such as a 90 degree T-bend to the outlet.

The transport gas may usually be air but can also be any other suitable type of gas.

The clumps of damp material may therefore be retained and continue to circulate around the periphery in the internal channel of the casing where they exposed to the passage of transport gas.

This may cause the moisture at the surface of the clumps of damp material to evaporate so that the material in the surface layer is dried. As the clumps circulate the resulting tumbling action and impact by the fine particles (e.g. coal particles) may abrade the dry surface layer. The fine dry particles (e.g. fine dry coal particles) may be released from the surface becoming entrained in the transport gas flow and may be carried through the filter element to continue their passage to the downstream process. In this way the clumps of damp material retained in the casing may be dried and progressively disintegrate allowing the material to pass to the downstream process.

The gas velocity within the inlet and outlet may be dependent on the nature of the conveying system (e.g. pneumatic conveying system) and may typically be in the range of about 4 m/s to 30 m/s. This may provide a rotational speed of the transport gas of between about 0.1 and 5.0 radians/sec within the casing. This is important for maintaining the required cyclonic effect.

The apparatus may be intended to work with materials at ambient temperature and at elevated temperature such as up to about 50° C.-70° C.

In the case of materials at ambient temperature drying may be by natural evaporation and the damp material clumps collected in the device may dry, disintegrate and pass through the system within a period of about 1 to 4 hours.

In the case of materials at elevated temperature the transport gas may become heated by the material. This will improve its drying properties and shorten the residence time. In the example given of pulverised coal injection to blast furnaces the coal will typically be about 60° C. In this case the residence time may be expected to be less than about 1 hour.

According to a third aspect of the present invention there is provided apparatus for conveying and separating rocks and/or debris from material being conveyed, said apparatus comprising:

a casing which has an internal channel extending around an inner circumference of the casing;

a filter element located within the casing;

an inlet through which the conveyed material and a transport gas is capable of being fed into the casing and the internal channel;

an outlet through which finer material and transport gas is capable of exiting the casing; and

wherein the rocks and/or debris are trapped outside the filter element thereby allowing this larger material to be removed and separated.

The material may therefore be pneumatically conveyed.

The material being conveyed may therefore be described as oversized material containing rocks and/or debris.

A particular example of the material being conveyed is copper concentrate where rock and debris may get into and contaminate the copper concentrate material and the apparatus conveying the copper concentrate quickly becomes clogged and blocked.

The apparatus may comprise an inlet pipe which passes the oversized material to an entry filter chamber which may be substantially tangentially oriented. Oversized material may therefore enter the filter chamber through the inlet pipe.

Inside the filter chamber there may be a circulating air flow. The circulating air flow may throw large particles to the outside of the filter element assembly by centrifugal force. Finer material such as the copper concentrate may be carried radially inwards by the conveying airflow and passes through openings in the filter element assembly. The finer material may then be carried upwards by the conveying airflow and leaves the filter chamber via the outlet pipe.

Oversized particles may therefore collect around the periphery of the filter chamber.

The oversized particles may then be removed manually. For example, a top cover may be removed and then the filter element itself. This allows access to the filter chamber where the rocks and/or debris can then be removed.

A differential pressure transmitter may also be connected across the inlet pipe and the outlet pipe. This allows for a control system to be used and to be connected to a high differential pressure alarm to alert operators as to when a filter should be cleaned. As an example, during normal operation at the maximum conveying rate the pressure drop across the filter is expected to be 0.5 bar.

The filter element may be manufactured from a range of rings spaced apart on rods extending from a top plate. As the filter rings wear out they can be individually replaced as required.

The apparatus may also comprise an automatic mechanism for removing the separated rocks and/or debris. A dome valve may be used to control the flow of the oversized material. The oversized material may then enter the filter chamber which has a filter element centrally located and operates as previously described. The finer material then passes along an outlet pipe. A rotating dome valve member may then be used to open and close the entrance to the filter chamber. When the rotating dome valve member is in the open position the filter chamber may be cleaned and the rocks and/or debris may be removed.

According to a fourth aspect of the present invention there is provided a method for conveying and separating rocks and/or debris from material being conveyed, said apparatus comprising:

providing a casing which has an internal channel extending around an inner circumference of the casing;

providing a filter element located within the casing;

providing an inlet through which the conveyed material and a transport gas is capable of being fed into the casing and the internal channel;

providing an outlet through which finer material and transport gas is capable of exiting the casing; and

wherein the rocks and/or debris are trapped outside the filter element thereby allowing this larger material to be removed and separated.

The method may use the apparatus according to any of the previous aspects.

Use of an apparatus according to any previous aspect for conveying and separating rocks and/or debris from material being conveyed.

### BRIEF DESCRIPTION OF THE DRAWINGS

Embodiments of the present invention will now be described, by way of example only, with reference to the accompanying drawings in which:

FIG. 1 is a representative view of apparatus capable of drying pneumatically conveyed material according to an embodiment of the present invention;

FIG. 2 is a sectional top view of the apparatus shown in FIG. 1;

FIG. 3 is a view of a filter element forming part of the apparatus shown in FIGS. 1 and 2;

FIGS. 4 to 6 are views of an apparatus capable of pneumatically conveying material according to a further embodiment of the present invention where there is a manually operated cleaning mechanism;

FIGS. 7 to 10 are views of a filter element assembly used in the apparatus shown in FIGS. 4 to 6;

FIGS. 11 to 14 are views of an apparatus capable of pneumatically conveying material according to a yet further embodiment of the present invention where there is an automatically operated cleaning mechanism.

### BRIEF DESCRIPTION

Generally speaking, the present invention resides in the provision of apparatus for drying conveyed material such as pneumatically conveyed material. Although the embodiment described below relates to pneumatically conveyed material it should be understood that this is non-limiting and the apparatus described herein is capable of drying any type of granular or powder-like material that has a degree of dampness. The apparatus may be described as a cyclonic separator and drier.

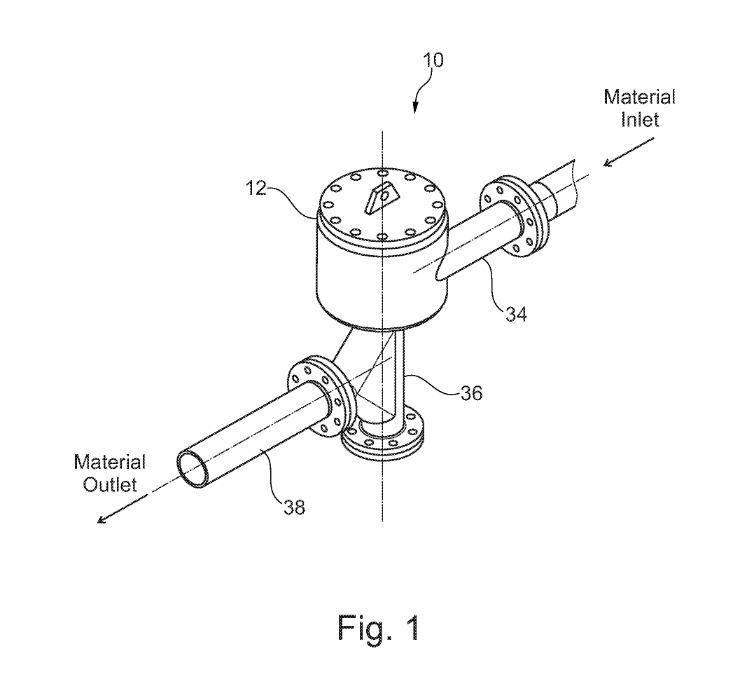

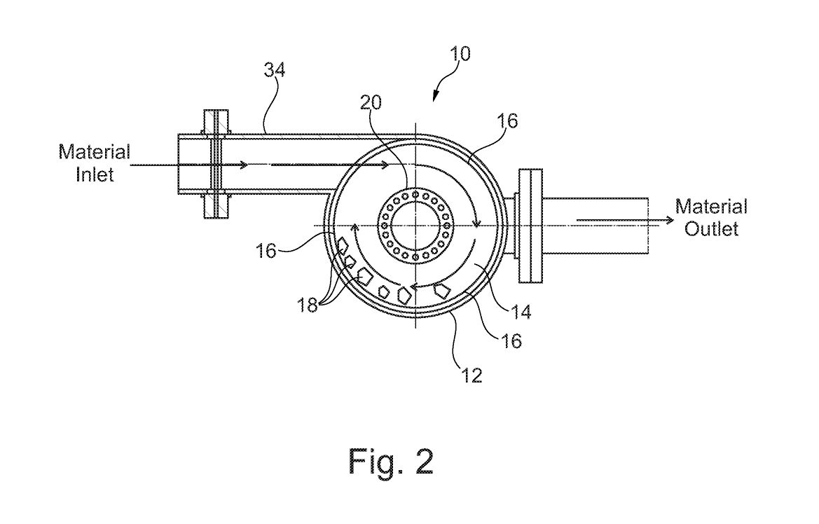

FIGS. 1 and 2 represents drying apparatus of the present invention generally referred to with the reference numeral 10. The drying apparatus comprises a casing 12 which is preferably circular in shape. As shown in FIG. 2 the casing 12 is hollow with an internal channel 14 (e.g. internal circular channel) which extends in an annular fashion around the inside of the casing 12. The diameter of the internal channel 14 is about 20 cm to about 100 cm.

The circular channel 14 has a surface 16 extending in a circular fashion onto which clumps of damp material may be displaced onto. The surface 16 of the circular channel 14 is smooth or may have intrusions against which agglomerated material will collide causing them to break down more quickly.

The outer surface of the circular channel may be equipped with an external source of heat. Heat transmitted through the wall of the circular channel by conduction is intended to enhance evaporation causing the damp clumps to be dried more quickly.

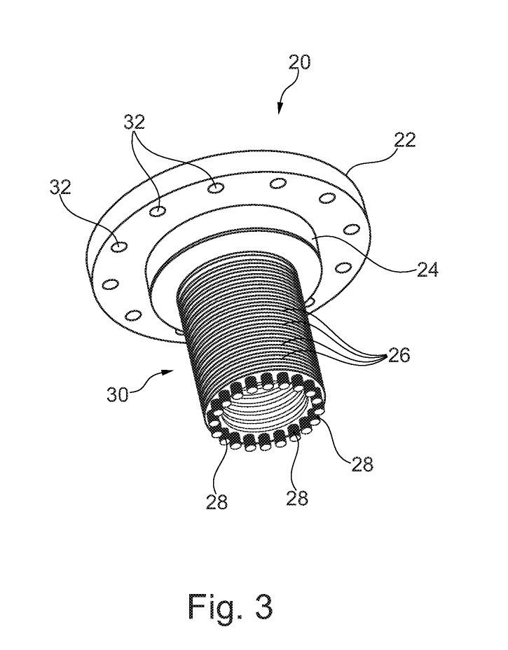

Inserted into the apparatus 10 there is a filter element 20. The filter element 20 is more clearly shown in FIG. 3. The filter element 20 has an end plate 22 onto which is attached a circular member 24 and a tubular filter element 30. The tubular filter element 30 comprises a series of rings 26 and vertical bars 28 e.g. vertical round bars. The series of rings 26 provide a tubular filter element 30 with a diameter of about 5 cm to about 40 cm. There is a gap between the rings which is about 0.3 mm to about 2.0 mm,

The end plate 22 in the filter element 20 has a series of apertures 32 which can be used to attach the filter element 20 to the rest of the apparatus 10.

As shown in FIGS. 1 and 2 the apparatus 10 also comprises an inlet pipe 34 through which damp material is capable of being fed. The inlet pipe 34 in the embodiment shown in FIG. 1 is mounted tangentially onto the casing 12. In alternative embodiments the inlet pipe may be attached in any suitable angle such as about +/−20 degrees from the tangent.

The inlet pipe has a diameter of about 2 cm to about 40 cm.

FIG. 1 shows that there is a pipe 36 located below the casing 12 which, for example, can be in the form of a 90 degree T-bend. The pipe has a diameter of about 2 cm to about 40 cm.

The pipe 36 is then connected to a material outlet pipe 38 through which dried material is capable of exiting. The material outlet pipe 38 has a diameter of about 2 cm to about 40 cm.

The apparatus 10 in use will now be described.

In use, material and transport gas enters the casing 12 through the inlet pipe 34. The inlet pipe 34 may be located at a high angle to the casing 12 and preferably tangentially.

The material is any type of damp particulate material such as powder or granular type material that contains a degree of dampness. In particular embodiments, the apparatus 10 may be placed in a pulverised coal injection system where the coal is damp. The level of dampness (i.e. moisture) in the clumps of damp material may range from about 1 wt. %-30 wt. % or 0 wt. %-1 wt. % of the total weight of the material.

The size of the particles of the damp material being fed into the inlet pipe 34 may be about 0.5 cm to 20 cm.

The particles of the damp material may be travelling at a speed of 4 ms⁻¹ to about 30 ms⁻¹ when they enter the casing 12.

The volume of material capable of being fed into the apparatus 10 may range up to about 50 tonnes per hour or even higher. The apparatus 10 can therefore be easily scaled to a small type of apparatus for lab scale devices to large industrial uses such as in a pulverised coal injection system.

The damp material 18 on exiting the inlet pipe 34 enters the casing 12. As shown in FIG. 2 the damp material circulates around the periphery of the casing 12 and becomes lodged on the inner surface 16 of the casing 12 in the internal channel 14. Any clumps of damp material 12 that may be present are thrown to the periphery of the casing 12 due to cyclonic action and are prevented from passing through the system. The finer dry material remains entrained in the transport gas flow and is drawn towards the centre of the casing 12 passing through the filter element 20 and downwards through a bent pipe 36 such as a 90 degree T-bend to the outlet pipe 38. The transport gas is usually air but can also be any other suitable type of gas.

The clumps of damp material 18 are retained and continue to circulate around the periphery of the casing 12 where they exposed to the passage of transport gas.

This causes the moisture at the surface of the clumps of damp material 18 to evaporate so that the material in the surface layer is dried. As the clumps circulate the resulting tumbling action and impact by the fine particles (e.g. coal particles) abrades the dry surface layer. The fine dry particles (e.g. fine dry coal particles) released from the surface become entrained in the transport gas flow and are carried through the filter element 20 to continue their passage to the downstream process. In this way the clumps of damp material retained in the casing 12 are dried and progressively disintegrate allowing the material to pass to the downstream process.

The gas velocity within the inlet and outlet pipes 34, 38 of the apparatus 10 will be dependent on the nature of the conveying system (e.g. pneumatic conveying system) and will typically be in the range of about 4 m/s to 30 m/s. This will provide a rotational speed of the gas of between about 0.1 and 5.0 radians/sec within the circular casing 12. This is important for maintaining the required cyclonic effect.

The apparatus 10 is intended to work with materials at ambient temperature and at elevated temperature such as up to about 50-70° C.

In the case of materials at ambient temperature drying will be by natural evaporation and it is anticipated that damp material clumps collected in the apparatus 10 will dry, disintegrate and pass through the system within a period of about 1 to 4 hours.

In the case of materials at elevated temperature the transport gas will become heated by the material. This will improve its drying properties and shorten the residence time. In the example given of pulverised coal injection to blast furnaces the coal will typically be about 60° C. In this case the residence time is expected to be less than about 1 hour.

The apparatus 10 is thought to have an additional advantage over traditional inline filters in that any fibrous, over-sized or tramp material entering the device will be deposited around the periphery of the casing. Centrifugal force will tend to prevent this debris from moving radially inwards and so it is less likely to become enmeshed in the filter element and cause clogging.

This apparatus 10 is intended to be installed in the pneumatic conveying pipeline of such applications. Its purpose is to capture any damp material and prevent it from passing into the downstream system where it could cause pipe blockages. The clumps of damp material are held within the casing 12 of the apparatus 10. The passage of transport gas evaporates the moisture causing the clumps of material to progressively dry out and disintegrate so that the material can pass to the downstream process.

The apparatus is also capable of being retro-fitted to existing systems.

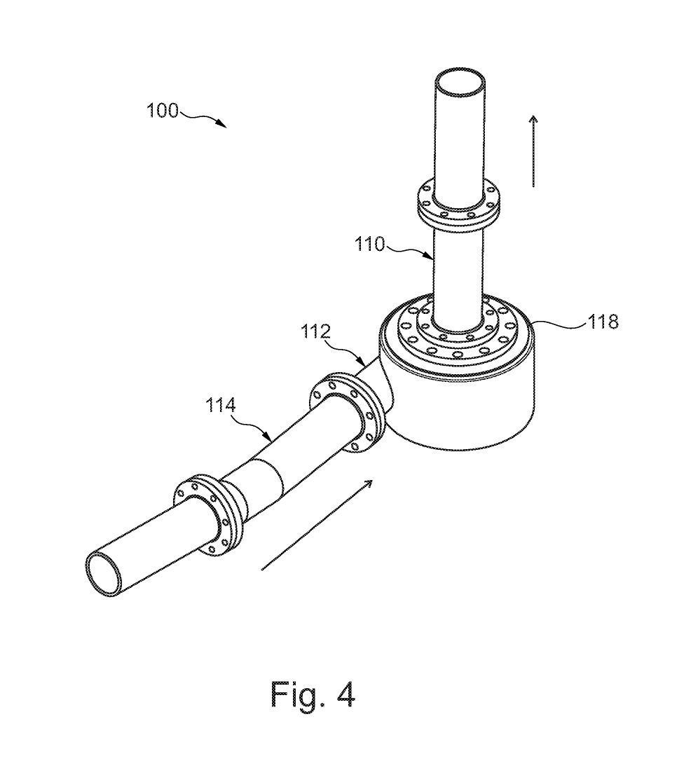

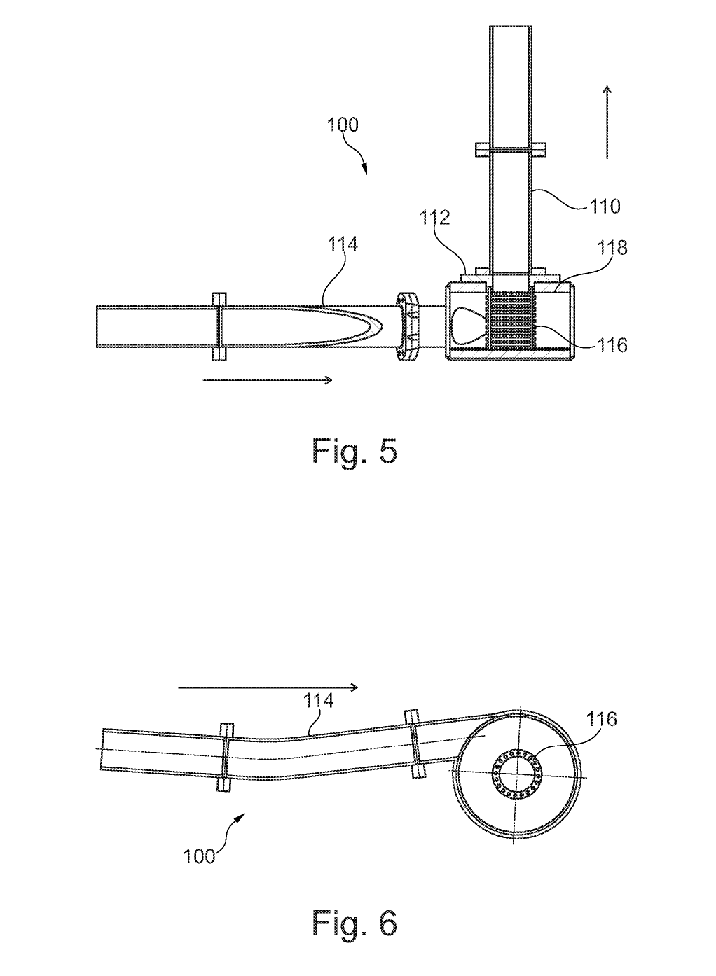

As shown in FIGS. 4 to 6 the present invention also relates to an apparatus 100 for conveying oversized material. The oversized material may comprise rocks and/or debris. A particular example is copper concentrate where rock and debris may get into and contaminate the copper concentrate material and the apparatus conveying the copper concentrate quickly becomes clogged and blocked.

The apparatus 100 shows that there is an inlet pipe 114 which passes the oversized material to a tangential entry filter chamber 112. Oversized material therefore enters the filter chamber 112 through the tangential inlet pipe 114. Inside the filter chamber 112 there is a circulating air flow. The circulating air flow throws large particles to the outside of the filter element assembly 116 by centrifugal force. Finer material such as the copper concentrate is carried radially inwards by the conveying airflow and passes through openings in the filter element assembly 116. The finer material is then carried upwards by the conveying airflow and leaves the filter chamber 112 via the outlet pipe 110.

Oversized particles therefore collect around the periphery of the filter chamber 112. The oversized particles are then removed manually by first removing a top cover 118 and then the filter element 116 itself. This allows access to the filter chamber where the rocks and debris can then be removed.

Although not shown a differential pressure transmitter may be connected across the inlet pipe 114 and the outlet pipe 110. This allows for a control system to be used and to be connected to a high differential pressure alarm to alert operators as to when a filter should be cleaned. As an example, during normal operation at the maximum conveying rate the pressure drop across the filter is expected to be 0.5 bar.

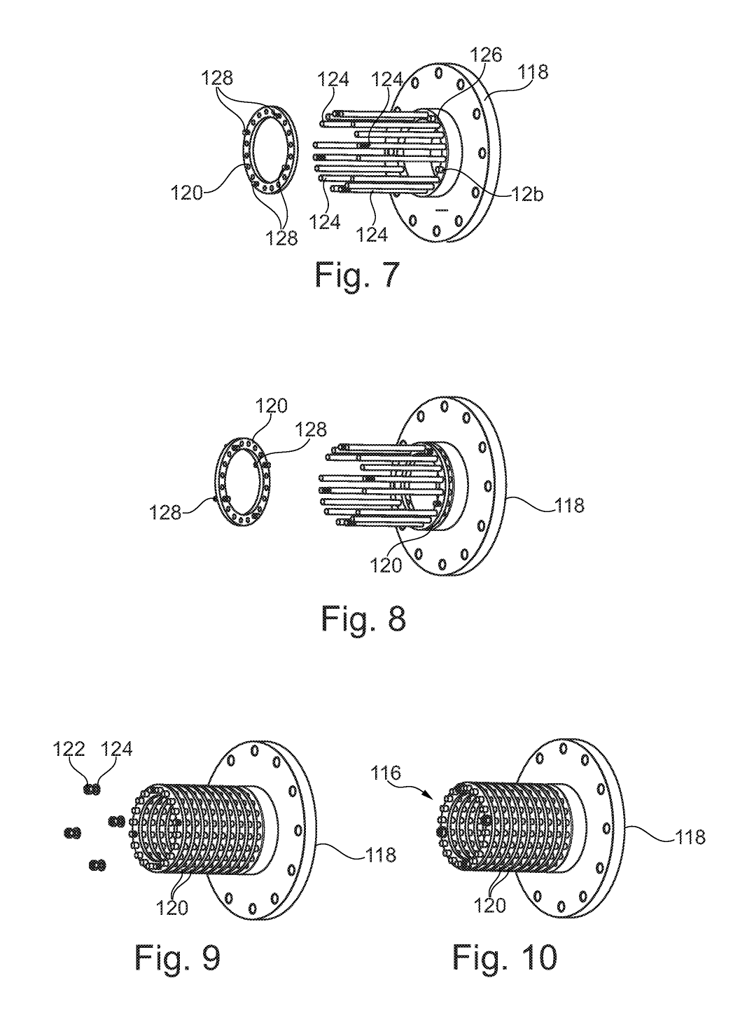

FIGS. 7 to 10 show the assembly of the filter element 116. In FIG. 7 there is shown the top cover plate 118 with series of rods extending from the bottom surface of the top plate 118. There is a combination of longer rods 124 and shorter rods 126 which are intended to fit through apertures on a filter ring 120. FIG. 8 shows one filter ring 120 attached. The short rods 126 act as a spacer to maintain a gap (e.g. about 15 mm) between the top of the filter ring 120 and the top cover 118. It is also shown that the filter rings 120 contain four further short rods 128 which also act as spacers. As the filter rings 120 wear out they can be individually replaced as required. The rods 124, 126, 128 can be made from hardened steel to improve wear resistance. The rings 120 can also be coated on their outside with wear resistance material such as stellite or can be made from hardened steel. The filter chamber 112 can be made from a hardened material such as tungsten carbide.

As shown in FIG. 9 a series of rings 120 are attached and finally fastened with nuts 122 and washers 124 and some welding.

FIG. 10 shows the filter assembly 116 fully assembled.

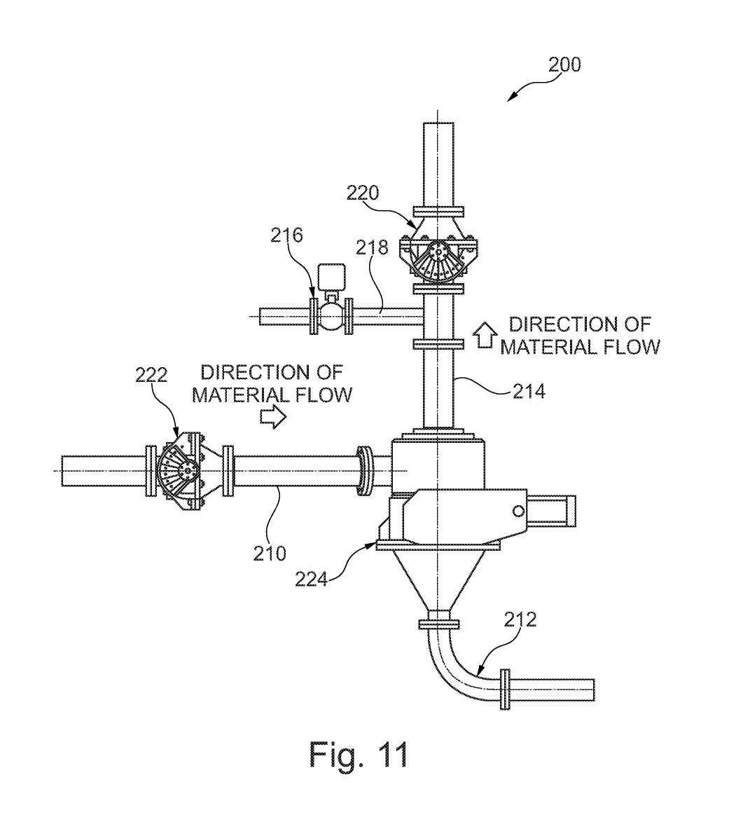

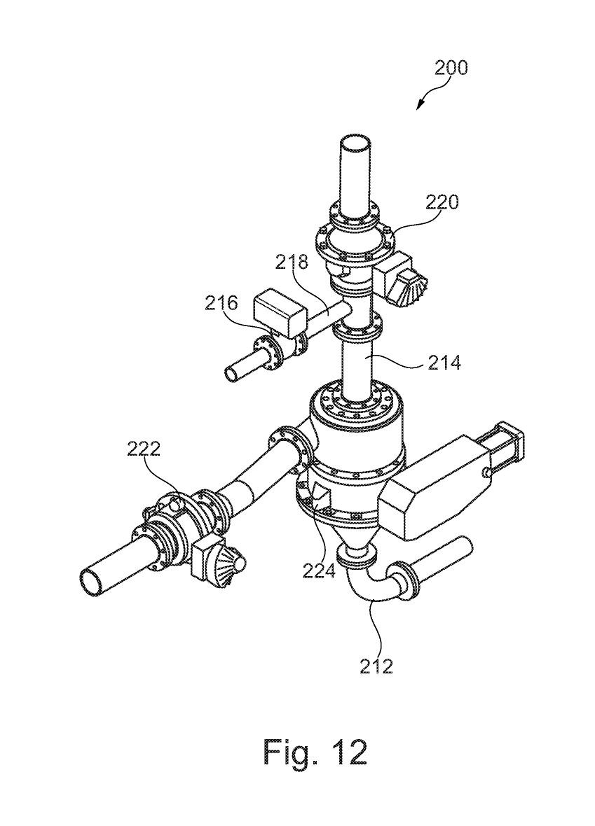

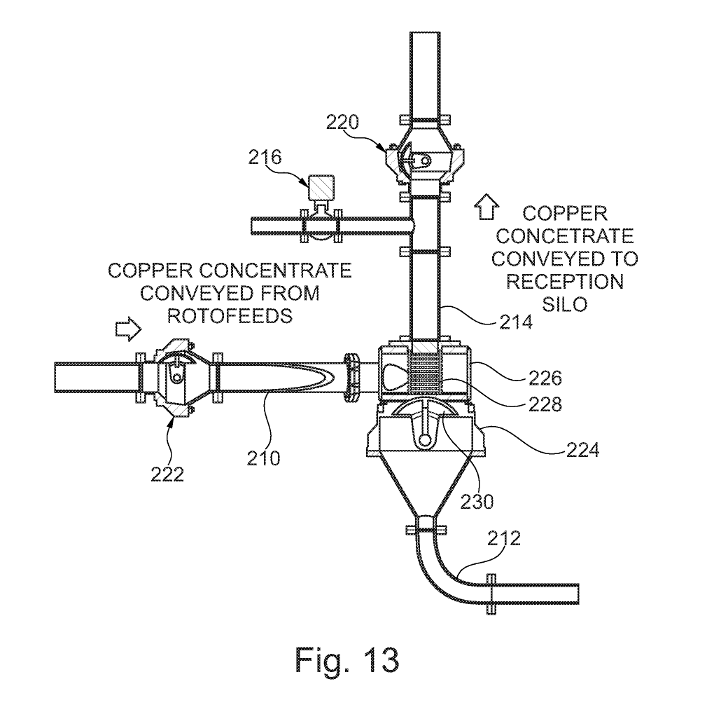

FIGS. 11 to 14 are views of an apparatus 200 capable of pneumatically conveying material according to a yet further embodiment of the present invention where there is an automatically operated cleaning mechanism. As shown there is an inlet pipe 210 that transports oversized material which may comprise rocks and/or debris. A dome valve 222 is used to control the flow of the oversized material. The oversized material then enters the filter chamber 228 which has a filter element 226 centrally located and operates as previously described. The finer material then passes along outlet pipe 214. There is also shown a filter cleaning air valve 216 and a further dome valve 220.

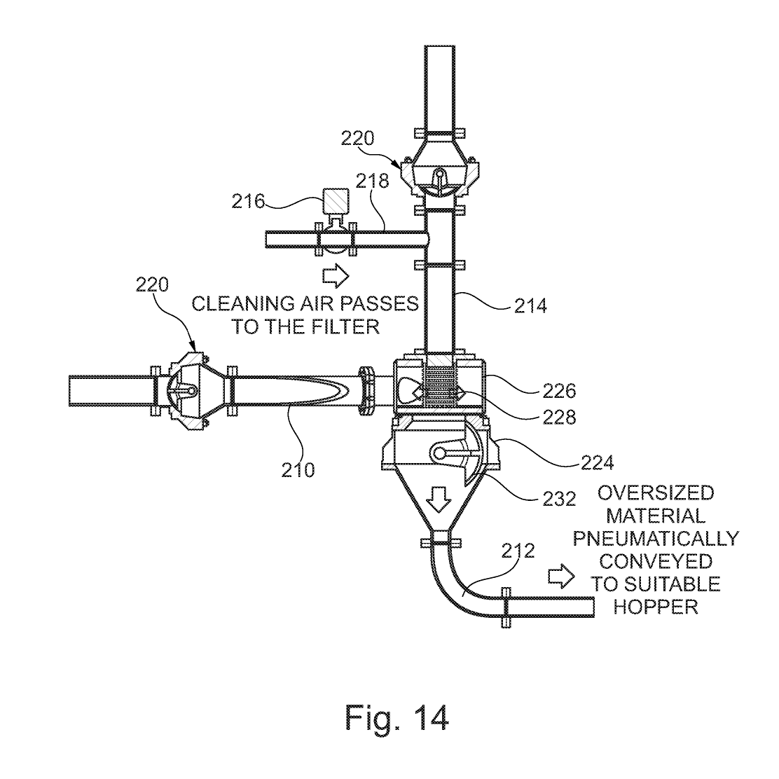

FIG. 13 shows there is a rotating dome valve member 232 which can be used to open and close the entrance to the filter chamber 228. FIG. 14 shows the rotating dome valve member 232 in the open position where the filter chamber may be cleaned and the rocks and debris may be removed.

Whilst specific embodiments of the present invention have been described above, it will be appreciated that departures from the described embodiments may still fall within the scope of the present invention. For example, any suitable type of cyclonic apparatus and shape of casing may be used to dry the material.

1-50. (canceled)

51. An apparatus for drying material comprising:
a casing which has an internal channel extending around the inner circumference of the casing;
a filter element located within the casing;
an inlet through which damp material and a transport gas is capable of being fed into the casing and the internal channel; and
an outlet through which dried material and transport gas is capable of exiting; wherein the damp material is dried during its time in the internal channel of the casing and once dried is capable of passing through the filter element and exiting through the outlet.

52. The apparatus for drying material according to claim 51, wherein the damp material to be dried is pneumatically conveyed; and
wherein the apparatus is capable of drying particulate material (e.g. coal), granular or powder-like material that has a degree of dampness.

53. The apparatus for drying material according to claim 51, wherein the casing is circular in shape; and
wherein the casing is hollow with an internal circular channel which extends in an annular fashion around the inside of the casing;
wherein the diameter of the internal channel is about 2 cm to about 40 cm; and
wherein the internal channel has a surface extending in a circular fashion onto which clumps of damp material are capable of being displaced onto.

54. The apparatus for drying material according to claim 51, wherein the filter element has an end plate capable of attaching the filter element to the rest of the apparatus; and wherein the filter element is tubular in shape.

55. The apparatus for drying material according to claim 51, wherein the filter element comprises a series of rings and vertical bars and where there is a gap between alternate rings which has a filtering function;
wherein the vertical bars are vertical round bars;
wherein the gap between the rings is about 0.3 mm to about 2.0 mm; and
wherein the filter element has a diameter of about 5 cm to about 40 cm.

56. The apparatus for drying material according to claim 51, wherein the inlet is an inlet pipe through which damp material is capable of being fed;
wherein the inlet is mounted tangentially or substantially tangentially onto the casing;
wherein the inlet is attached to the casing in any suitable angle of about +20 degrees to about −20 degrees relative to a tangential entry; and
wherein the inlet has a diameter of about 2 cm to about 40 cm.

57. The apparatus for drying material according to claim 51, wherein attached to the casing there is a conduit (e.g. a pipe) through which the dried material is capable of exiting the casing;
wherein the conduit is in the form of a bent pipe such as a 90 degree T-bend;
wherein the conduit has a diameter of about 2 cm to about 40 cm;
wherein the conduit is connected to the outlet through which dried material is capable of exiting.

58. The apparatus for drying material according to claim 51, wherein the material outlet has a diameter of about 2 cm to about 40 cm;
wherein the apparatus is installed in a pneumatic conveying pipeline to capture any damp material and prevent it from passing into a downstream system where it could cause pipe blockages;
wherein the apparatus is capable of being retro-fitted to existing systems; and
wherein the apparatus is placed in a pulverised coal injection system where lumps of coal are the damp material.

59. A method for drying damp material, said method comprising:
providing a casing which has an internal channel extending around the inner circumference of the casing;
providing a filter element located within the casing;
providing an inlet through which damp material and a transport gas is capable of being fed into the casing and the internal channel; and
providing an outlet through which dried material and transport gas is capable of exiting;
wherein the damp material is dried during its time in the internal channel of the casing and once dried is capable of passing through the filter element and exiting through the outlet.

60. The method for drying damp material according to claim 59, wherein, in use, material and transport gas enter the casing through the inlet;
wherein the damp material is any type of damp material including, particulate material, powder or granular type material that contains a degree of dampness; and
wherein the level of dampness (i.e. moisture) in the clumps of damp material may range from about 1 wt. %-30 wt. % or 0 wt. % -1 wt. % of the total weight of the material;

61. The method for drying damp material according to claim 59, wherein the size of the particles of the damp material being fed into the inlet ranges from about 0.5 cm to 20 cm;
wherein the particles of the damp material are travelling at a speed of 4 ms-1 to 30 ms-1 when they enter the casing; and
wherein the damp material circulates around the periphery of the casing in the internal channel and is capable of becoming lodged on the inner surface of the casing, where any clumps of damp material that are present are thrown to the periphery of the casing due to cyclonic action and are prevented from passing through the system, and the finer dry material remains entrained in the transport gas flow and is drawn towards the center of the casing passing through the filter element and downwards.

62. The method for drying damp material according to claim 59, wherein the transport gas is air;
wherein clumps of damp material are retained in the casing and continue to circulate around the periphery of the casing where they exposed to the passage of transport gas; and
wherein the gas velocity within the inlet and outlet is dependent on the nature of the conveying system (e.g. pneumatic conveying system) and is in the range of about 4 m/s to 30 m/s which provides a rotational speed of the transport gas of between about 0.1 and 5.0 radians/sec within the casing.

63. The method for drying damp material according to claim 59, wherein the apparatus is capable of working with materials at ambient temperature and at elevated temperature such as up to about 50-70° C. and the damp material clumps collected in the device are capable of drying, disintegrating and passing through the apparatus;
wherein in the case of materials at elevated temperature the transport gas is capable of becoming heated by the material which will improve its drying properties and shorten the residence time; and
wherein the method is used in pulverized coal injection and blast furnaces and lumps of coal will be about 50° C.-80° C.

64. An apparatus for conveying and separating rocks and/or debris from material being conveyed, said apparatus comprising:
a casing which has an internal channel extending around an inner circumference of the casing;
a filter element located within the casing;
an inlet through which the conveyed material and a transport gas is capable of being fed into the casing and the internal channel; and
an outlet through which finer material and transport gas is capable of exiting the casing; and
wherein the rocks and/or debris are trapped outside the filter element thereby allowing this larger material to be removed and separated.

65. The apparatus for conveying and separating rocks and/or debris from material being conveyed according to claim 64, wherein the material is pneumatically conveyed;
wherein the apparatus comprises an inlet pipe which passes the material to an entry filter chamber; and
wherein inside the filter chamber there is a circulating air flow and the circulating air flow throws large particles to the outside of the filter element assembly by centrifugal force; and where finer material is carried radially inwards by the conveying airflow and passes through openings in the filter element assembly; and
wherein the finer material is carried upwards by the conveying airflow and leaves the filter chamber via the outlet pipe and wherein oversized particles are collected around the periphery of the filter chamber; and
wherein the oversized particles are removed manually by removing a cover and then the filter element itself which allows access to the filter chamber where the rocks and debris can then be removed; or
wherein the oversized particles are removed automatically by using a dome valve to open and close an opening to the rocks and/or debris trapped outside the filter element.

66. The apparatus for conveying and separating rocks and/or debris from material being conveyed according to claim 64, wherein a differential pressure transmitter is connected across the inlet pipe and the outlet pipe and this allows for a control system to be used and to be connected to a high differential pressure alarm to alert operators as to when a filter should be cleaned.

67. A method for conveying and separating rocks and/or debris from material being conveyed, said apparatus comprising:
providing a casing which has an internal channel extending around an inner circumference of the casing;
providing a filter element located within the casing;
providing an inlet through which the conveyed material and a transport gas is capable of being fed into the casing and the internal channel; and
providing an outlet through which finer material and transport gas is capable of exiting the casing; and
wherein the rocks and/or debris are trapped outside the filter element thereby allowing this larger material to be removed and separated.
